(19) United States
(12) Patent Application Publication
(10) Pub. No.: US 2021/0387317 A1
(43) Pub. Date: Dec. 16, 2021

(54) NAIL GUN AND METHOD FOR OPERATING A NAIL GUN

(71) Applicant: Hilti Aktiengesellschaft, Schaan (LI)

(72) Inventor: Tilo DITTRICH, Feldkirch (AT)

(21) Appl. No.: 17/416,402

(22) PCT Filed: Nov. 27, 2019
(86) PCT No.: PCT/EP2019/082711

§ 371 Date: Jun. 18, 2021

(30) Foreign Application Priority Data
Dec. 19, 2018 (EP) 18214155.6

(51) Int. Cl. B25C 1/08; B25C 1/06

(52) U.S. Cl. CPC B25C 1/08; B25C 1/047; B25C 1/06

(57) ABSTRACT

A nail gun for driving fastening elements into a substrate in a driving-in direction is provided, comprising a drive piston which can be driven in a setting direction in order to push a fastening element into the substrate, a control unit which is provided for controlling a driving-in process of the nail gun, a sensor device for detecting a parameter during the driving-in process and for transmitting a signal, which is dependent on the detected parameter, to the control unit, wherein the control unit is provided for controlling driving-in energy, which is still to be transmitted to the fastening element as part of the driving-in process, depending on the detected parameter.

### TECHNICAL FIELD

The invention relates to a nail gun for driving fastening elements into a substrate in a driving-in direction. The invention furthermore relates to a method for operating a nail gun of this kind.

### PRIOR ART

Nail guns of this kind usually comprise a drive piston which can be driven in a setting direction in order to push a fastening element into the substrate. Particularly in the case of heterogeneous substrates, it may be the case that it is not possible to drive a fastening element into the substrate in the desired manner, but rather that said fastening element is braked or deflected by relatively hard constituent parts of the substrate, for example. This may potentially result in setting malfunctions in the case of which the fastening element and/or the substrate are damaged.

The object of the invention is to improve the setting quality of a nail gun.

### SUMMARY OF THE INVENTION

The object is achieved with a nail gun for driving fastening elements into a substrate in a driving-in direction, comprising a drive piston which can be driven in a setting direction in order to push a fastening element into the substrate, comprising a control unit which is provided for controlling a driving-in process of the nail gun, comprising a sensor device for detecting a parameter during the driving-in process and for transmitting a signal, which is dependent on the detected parameter, to the control unit, wherein the control unit is provided for controlling driving-in energy, which is still to be transmitted to the fastening element as part of the driving-in process, depending on the detected parameter. As a result, it is possible to adapt the driving-in energy to unforeseen circumstances, such as unusual braking of the fastening element, even during the driving-in process, so that the risk of setting malfunctions and/or damage to the fastening element and/or the substrate are/is reduced.

One advantageous embodiment is characterized in that the control unit is provided for reducing the driving-in energy which is still to be transmitted to the fastening element as part of the driving-in process. The control unit is preferably provided for ending the transmission of driving-in energy to the fastening element.

One advantageous embodiment is characterized in that the control unit is provided for redirecting a portion of driving-in energy which is provided for the driving-in process.

One advantageous embodiment is characterized in that the detected parameter comprises a force and/or acceleration which acts on the fastening element during the driving-in process, preferably transversely in relation to the driving-in direction.

One advantageous embodiment is characterized in that the nail gun comprises a drive which is provided for transmitting driving-in energy to the drive piston as the drive piston drives the fastening element into the substrate. The drive preferably comprises a positive-pressure chamber and is provided for generating a positive pressure in the positive-pressure chamber and allowing the positive pressure to act on the drive piston in order to transmit driving-in energy to the drive piston, wherein the positive-pressure chamber has a blow-off valve which can be controlled by the control unit, and wherein the control unit is provided for controlling the driving-in energy, which is still to be transmitted to the fastening element as part of the driving-in process, by opening the blow-off valve during the driving-in process. The positive-pressure chamber particularly preferably comprises a combustion chamber for a solid, liquid or gaseous fuel. The drive likewise preferably comprises an electrical energy store and a coil and is provided for electrically charging the electrical energy store, promptly discharging said electrical energy store, conducting a discharge current, which is produced in the process, through the coil and allowing electromagnetic energy which is released in the process to act on the drive piston in order to transmit driving-in energy to the drive piston, wherein the drive comprises a switch with which a current flow through the coil can be controlled, and wherein the control unit is provided for controlling the driving-in energy, which is still to be transmitted to the fastening element as part of the driving-in process, by operating the switch during the driving-in process.

The object is likewise achieved by way of a method for operating a nail gun for driving fastening elements into a substrate in a driving-in direction, comprising a drive piston which can be driven in a setting direction in order to push a fastening element into the substrate, comprising a) detecting a parameter during a driving-in process, and b) controlling, preferably reducing, driving-in energy, which is still to be transmitted to the fastening element as part of the driving-in process, depending on the detected parameter. The transmission of driving-in energy to the fastening element is particularly preferably ended.

One advantageous embodiment is characterized in that a portion of driving-in energy which is provided for the driving-in process is redirected. A further advantageous embodiment is characterized in that the detected parameter comprises a force and/or acceleration which acts on the fastening element during the driving-in process, in particular transversely in relation to the driving-in direction.

Further advantages, features and details of the invention can be gathered from the following description in which different exemplary embodiments are described in detail with reference to the drawing, in which:

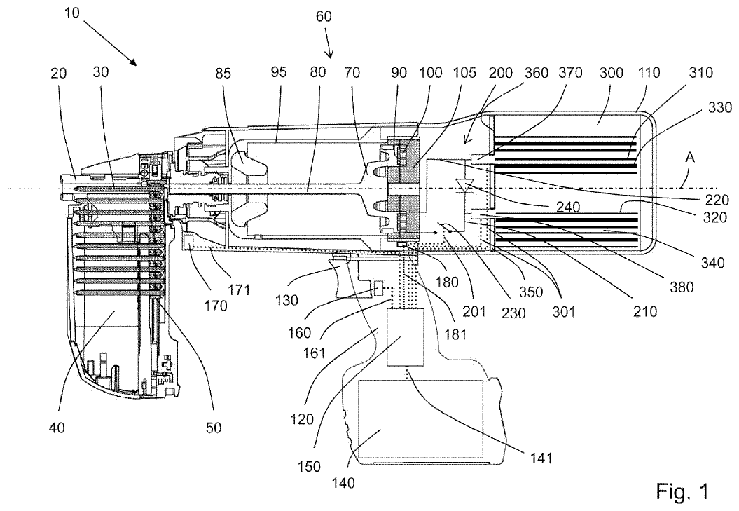

FIG. 1 shows a longitudinal section through a setting device,

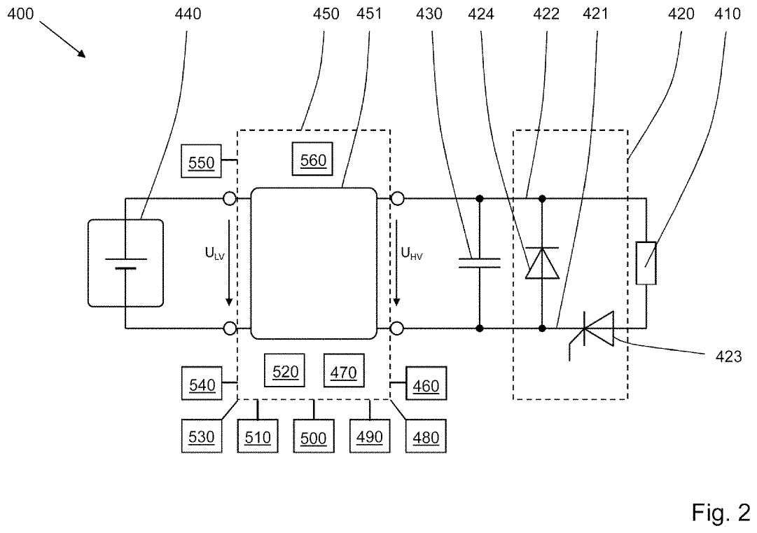

FIG. 2 shows a circuit diagram of the setting device from FIG. 1, and

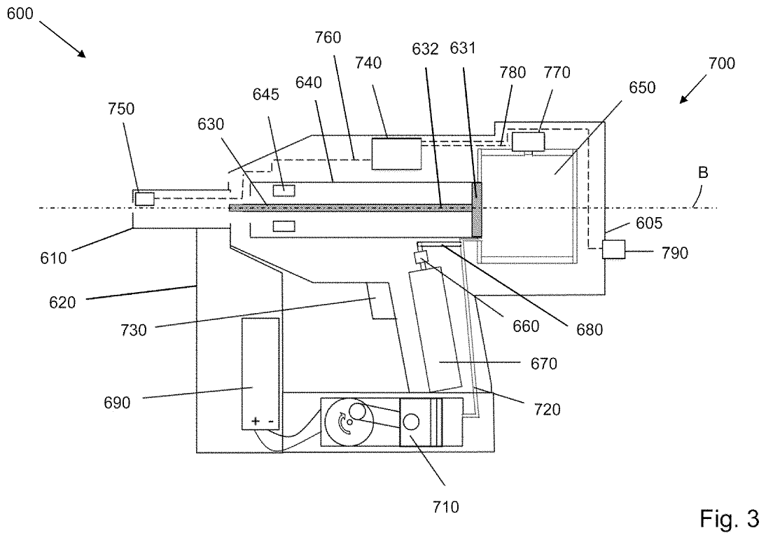

FIG. 3 schematically shows a further exemplary embodiment of a setting device.

### EXEMPLARY EMBODIMENTS

FIG. 1 illustrates a manually controlled setting device 10 for driving fastening elements into a substrate, not shown. The setting device 10 is designed as a nail gun and has a holder 20 which is designed as a nail guide and in which a fastening element 30, which is designed as a nail, is held in order to be driven into the substrate along a setting axis A (on the left-hand side in FIG. 1). For the purpose of supplying fastening elements to the holder, the setting device 10 comprises a magazine 40 in which the fastening elements are held in store individually or in the form of a fastening element strip 50 and are transported to the holder 20 one by one. To this end, the magazine 40 has a spring-loaded feed element, not specifically denoted. The setting device 10 has a driving-in element 60 which comprises a piston plate 70 and a piston rod 80. The driving-in element 60 is provided for conveying the fastening element 30 out of the holder 20, along the setting axis A, into the substrate. In the process, the driving-in element 60 is guided, by way of its piston plate 70, in a guide cylinder 95 along the setting axis A.

The driving-in element 60 is, for its part, driven by a drive which comprises a squirrel-cage rotor 90 which is arranged on the piston plate 70, an excitation coil 100, a soft-magnetic frame 105, a switching circuit 200 and a capacitor 300 with an internal resistance of 5 mOhm. The squirrel-cage rotor 90 consists of a preferably ring-like, particularly preferably circular ring-like, element with a low electrical resistance, for example composed of copper, and is fastened, for example soldered, welded, adhesively bonded, clamped or connected in an interlocking manner, to the piston plate 70 on that side of the piston plate 70 which is averted from the holder 20. In exemplary embodiments which are not shown, the piston plate itself is designed as a squirrel-cage rotor. The switching circuit 200 is provided for causing rapid electrical discharge of the previously charged capacitor 300 and conducting the discharge current, which flows in the process, through the excitation coil 100 which is embedded in the frame 105. The frame preferably has a saturation flux density of at least 1.0 T and/or an effective specific electrical conductivity of at most 10⁶ S/m, so that a magnetic field which is generated by the excitation coil 100 is intensified by the frame 105 and eddy currents in the frame 105 are suppressed.

In a ready-to-set position of the driving-in element 60 (FIG. 1), the driving-in element 60, by way of the piston plate 70, enters a ring-like recess, not specifically denoted, of the frame 105 such that the squirrel-cage rotor 90 is arranged at a small distance from the excitation coil 100. As a result, an excitation magnetic field, which is generated by a change in an electric excitation current flowing through the excitation coil, passes through the squirrel-cage rotor 90 and induces a secondary electric current which circulates in a ring-like manner in the squirrel-cage rotor 90 for its part. This secondary current, which builds up and therefore changes, in turn generates a secondary magnetic field which opposes the excitation magnetic field, as a result of which the squirrel-cage rotor 90 is subject to a Lorentz force which is repelled by the excitation coil 100 and drives the driving-in element 60 in the direction of the holder 20 and also the fastening element 30 which is held therein.

The setting device 10 further comprises a housing 110 in which the drive is held, a handle 120 with an operating element 130 which is designed as a trigger, an electrical energy store 140 which is designed as a rechargeable battery, a control unit 150, a tripping switch 160, a contact-pressure switch 170, a means for detecting a temperature of the excitation coil 100, which means is designed as a temperature sensor 180 which is arranged on the frame 105, and electrical connecting lines 141, 161, 171, 181, 201, 301 which connect the control unit 150 to the electrical energy store 140, to the tripping switch 160, to the contact-pressure switch 170, to the temperature sensor 180, to the switching circuit 200 and, respectively, to the capacitor 300. In exemplary embodiments which are not shown, the setting device 10 is supplied with electrical energy by means of a mains cable instead of the electrical energy store 140 or in addition to the electrical energy store 140. The control unit comprises electronic components, preferably interconnected on a printed circuit board to form one or more electrical control circuits, in particular one or more microprocessors.

When the setting device 10 is pressed against a substrate, not shown, (on the left-hand side in FIG. 1), a contact-pressure element, not specifically denoted, operates the contact-pressure switch 170 which, as a result, transmits a contact-pressure signal to the control unit 150 by means of the connecting line 171. This triggers the control unit 150 to initiate a capacitor charging process in which electrical energy is conducted from the electrical energy store 140 to the control unit 150 by means of the connecting line 141 and from the control unit 150 to the capacitor 300 by means of the connecting lines 301 in order to charge the capacitor 300. To this end, the control unit 150 comprises a switching converter, not specifically denoted, which converts the electric current from the electrical energy store 140 into a suitable charge current for the capacitor 300. When the capacitor 300 is charged and the driving-in element 60 is in its ready-to-set position illustrated in FIG. 1, the setting device 10 is in a ready-to-set state. Since charging of the capacitor 300 is implemented only by way of the setting device 10 pressing against the substrate, a setting process is rendered possible only when the setting device 10 is pressed against the substrate, for the purpose of increasing the safety of people in the area. In exemplary embodiments which are not shown, the control unit initiates the capacitor charging process as early as when the setting device is switched on or when the setting device is lifted away from the substrate or when a preceding driving-in process is completed.

When the operating element 130 is operated, for example by being pulled using the index finger of the hand which is holding the handle 120, with the setting device 10 in the ready-to-set state, the operating element 130 operates the tripping switch 160 which, as a result, transmits a tripping signal to the control unit 150 by means of the connecting line 161. This triggers the control unit 150 to initiate a capacitor discharging process in which electrical energy which is stored in the capacitor 300 is conducted from the capacitor 300 to the excitation coil 100 by means of the switching circuit 200 by way of the capacitor 300 being discharged.

To this end, the switching circuit 200, schematically illustrated in FIG. 1, comprises two discharge lines 210, 220 which connect the capacitor 300 to the excitation coil 200 and at least one discharge line 210 of which is interrupted by a normally open discharge switch 230. The switching circuit 200 forms an electrical oscillating circuit with the excitation coil 100 and the capacitor 300. Oscillation of this oscillating circuit back and forth and/or negative charging of the capacitor 300 may potentially have a negative effect on the degree of efficiency of the drive, but can be suppressed with the aid of a free-wheeling diode 240. The discharge lines 210, 220 are electrically connected, for example by soldering, welding, screwing, clamping or interlocking connection, to in each case one electrode 310, 320 of the capacitor 300 by means of electrical contacts 370, 380 of the capacitor 300 which are arranged on an end side 360 of the capacitor 300 that faces the holder 20. The discharge switch 230 is preferably suitable for switching a discharge current with a high current intensity and is designed, for example, as a thyristor. In addition, the discharge lines 210, 220 are at a small distance from one another, so that a parasitic magnetic field which is induced by them is as low as possible. By way of example, the discharge lines 210, 220 are combined to form a busbar and are held together by a suitable means, for example a retaining device or a clip. In exemplary embodiments which are not shown, the free-wheeling diode is connected electrically in parallel with the discharge switch. In further exemplary embodiments which are not shown, there is no free-wheeling diode provided in the circuit.

For the purpose of initiating the capacitor discharging process, the control unit 150 closes the discharge switch 230 by means of the connecting line 201, as a result of which a discharge current of the capacitor 300 with a high current intensity flows through the excitation coil 100. The rapidly rising discharge current induces an excitation magnetic field which passes through the squirrel-cage rotor 90 and induces a secondary electric current which circulates in a ring-like manner in the squirrel-cage rotor 90 for its part. This secondary current which builds up in turn generates a secondary magnetic field which opposes the excitation magnetic field, as a result of which the squirrel-cage rotor 90 is subject to a Lorentz force which is repelled by the excitation coil 100 and drives the driving-in element 60 in the direction of the holder 20 and also the fastening element 30 which is held therein. As soon as the piston rod 80 of the driving-in element 60 meets a head, not specifically denoted, of the fastening element 30, the fastening element 30 is driven into the substrate by the driving-in element 60. In exemplary embodiments which are not shown, the driving-in element already bears against the fastening element before or at the beginning of the capacitor discharge operation. As a result, it is all the more possible to transmit driving-in energy to the driving-in element as the driving-in element drives the fastening element into the substrate Excess kinetic energy of the driving-in element 60 is absorbed by a braking element 85 composed of a spring-elastic and/or damping material, for example rubber, by way of the driving-in element 60, by way of the piston plate 70, moving against the brake element 85 and being braked by said brake element until it comes to a standstill. The driving-in element 60 is then reset to the ready-to-set position by a resetting apparatus, not specifically denoted.

The capacitor 300, in particular its center of gravity, is arranged on the setting axis A behind the driving-in element 60, whereas the holder 20 is arranged in front of the driving-in element 60. Therefore, with respect to the setting axis A, the capacitor 300 is arranged in an axially offset manner in relation to the driving-in element 60 and in a radially overlapping manner with the driving-in element 60. As a result, a small length of the discharge lines 210, 220 can firstly be realized, as a result of which the resistances of said discharge lines can be reduced and therefore a degree of efficiency of the drive can be increased. Secondly, a small distance between a center of gravity of the setting device 10 and the setting axis A can be realized. As a result, tilting moments in the event of recoil of the setting device 10 during a driving-in process are small. In an exemplary embodiment which is not shown, the capacitor is arranged around the driving-in element.

The electrodes 310, 320 are arranged on opposite sides of a carrier film 330 which is wound around a winding axis, for example by metallization of the carrier film 330, in particular deposited by evaporation, wherein the winding axis coincides with the setting axis A. In exemplary embodiments which are not shown, the carrier film with the electrodes is wound around the winding axis such that a passage along the winding axis remains. In this case, the capacitor is, in particular, arranged around the setting axis for example. The carrier film 330 has a film thickness of between 2.5 μm and 4.8 μm at a charging voltage of the capacitor 300 of 1500 V, and a film thickness of, for example, 9.6 μm at a charging voltage of the capacitor 300 of 3000 V. In exemplary embodiments which are not shown, the carrier film is, for its part, composed of two or more individual films which are layered one above the other. The electrodes 310, 320 have a sheet resistance of 50 ohms/sq.

A surface of the capacitor 300 is in the form of a cylinder, in particular a circular cylinder, the cylinder axis of which coincides with the setting axis A. A height of said cylinder in the direction of the winding axis is substantially the same size as its diameter measured perpendicularly in relation to the winding axis. On account of a small ratio of height to diameter of the cylinder, a low internal resistance given a relatively high capacitance of the capacitor 300 and, not least, a compact construction of the setting device 10 are achieved. A low internal resistance of the capacitor 300 is also achieved on account of a large line cross section of the electrodes 310, 320, in particular on account of a high layer thickness of the electrodes 310, 320, wherein the effects of the layer thickness on a self-healing effect and/or on a service life of the capacitor 300 should be taken into consideration.

The capacitor 300 is mounted on the rest of the setting device 10 in a manner damped by means of a damping element 350. The damping element 350 damps movements of the capacitor 300 relative to the rest of the setting device 10 along the setting axis A. The damping element 350 is arranged on the end side 360 of the capacitor 300 and completely covers the end side 360. As a result, the individual windings of the carrier foil 330 are subject to uniform loading by recoil of the setting device 10. In this case, the electrical contacts 370, 380 protrude from the end surface 360 and pass through the damping element 350. For this purpose, the damping element 350 in each case has a clearance through which the electrical contacts 370, 380 protrude. The connecting lines 301 respectively have a strain-relief and/or expansion loop, not illustrated in any detail, for compensating for relative movements between the capacitor 300 and the rest of the setting device 10. In exemplary embodiments which are not shown, a further damping element is arranged on the capacitor, for example on that end side of said capacitor which is averted from the holder. The capacitor is then preferably clamped between two damping elements, that is to say the damping elements bear against the capacitor with prestress. In further exemplary embodiments which are not shown, the connecting lines have a degree of rigidity which continuously decreases as the distance from the capacitor increases.

FIG. 2 illustrates an electrical circuit diagram 400 of a setting device, not shown further, for driving fastening elements into a substrate, not shown. The setting device has a housing, not shown, a handle, not shown, with an operating element, a holder, not shown, a magazine, not shown, a driving-in element, not shown, and a drive for the driving-in element. The drive comprises a squirrel-cage rotor, not shown, which is arranged on the driving-in element, an excitation coil 410, a soft-magnetic frame, not shown, a switching circuit 420, a capacitor 430, an electrical energy store 440 which is designed as a rechargeable battery, and a control unit 450 with a switching converter 451 which is designed, for example, as a DC/DC converter. The switching converter 451 has a low-voltage side U_{LV} which is electrically connected to the electrical energy store 440 and a high-voltage side U_{HV} which is electrically connected to the capacitor 430.

The switching circuit 420 is provided for causing rapid electrical discharge of the previously charged capacitor 430 and conducting the discharge current, which flows in the process, through the excitation coil 410. To this end, the switching circuit 420 comprises two discharge lines 421, 422 which connect the capacitor 430 to the excitation coil 420 and at least one discharge line 421 of which is interrupted by a normally open discharge switch 423. A free-wheeling diode 424 suppresses excessive oscillation back and forth of an oscillating circuit which is formed by the switching circuit 420 with the excitation current 410 and the capacitor 430.

When the setting device is pressed against the substrate, the control unit 450 initiates a capacitor charging process in which electrical energy is conducted from the electrical energy store 440 to the switching converter 451 of the control unit 450 and from the switching converter 451 to the capacitor 430 in order to charge the capacitor 430. In the process, the switching converter 451 converts the electric current from the electrical energy store 440 at an electrical voltage of, for example, 22 V into a suitable charging current for the capacitor 430 at an electrical voltage of, for example, 1500 V.

Operation of the operating element, not shown, triggers the control unit 450 to initiate a capacitor discharging process in which electrical energy which is stored in the capacitor 430 is conducted from the capacitor 430 to the excitation coil 410 by means of the switching circuit 420 by way of the capacitor 430 being discharged. For the purpose of initiating the capacitor discharging process, the control unit 450 closes the discharge switch 430, as a result of which a discharge current of the capacitor 430 with a high current intensity flows through the excitation coil 410. As a result, the squirrel-cage rotor, not shown, is subject to a Lorentz force which is repelled by the excitation coil 410 and drives the driving-in element. The driving-in element is then reset to a ready-to-set position by a resetting apparatus, not shown.

An amount of energy in the current flowing through the excitation coil 410 during rapid discharge of the capacitor 430 is controlled by the control unit 450, in particular in an infinitely variable manner, by way of a charging voltage (U_{HV}), which is applied to the capacitor 430, being adjusted during and/or at the end of the capacitor charging process and before the beginning of rapid discharge. Electrical energy which is stored in the charged capacitor 430 and therefore also the amount of energy in the current flowing through the excitation coil 410 during rapid discharge of the capacitor 430 are proportional to the charging voltage and therefore can be controlled by means of the charging voltage. The capacitor is charged during the capacitor charging process until the charging voltage U_{HV} has reached a target value. The charging current is then switched off. When the charging voltage decreases before rapid discharge, for example on account of parasitic effects, the charging current is switched on again until the charging voltage U_{HV} has reached the target value once again.

The control unit 450 controls the amount of energy in the current flowing through the excitation coil 410 during rapid discharge of the capacitor 430 depending on a plurality of control variables. To this end, the setting device comprises a means for detecting a temperature of the excitation coil 410, which means is designed as a temperature sensor 460, and means for detecting a capacitance of the capacitor, which means is designed, for example, as a calculation program 470 and calculates the capacitance of the capacitor from a profile of a current intensity and an electrical voltage of the charging current during the capacitor charging process. The setting device further comprises a means for detecting a mechanical loading variable of the setting device, which means is designed as an acceleration sensor 480. The setting device further comprises a means for detecting a depth to which the fastening element is driven into the substrate, which means comprises a, for example, optical, capacitive or inductive proximity sensor 490 which comprises a inverse position of the driving-in element, not shown. The setting device further comprises a means for detecting a speed of the driving-in element, which means has a means, which is designed as a first proximity sensor 500, for detecting a first time, at which the driving-in element passes a first position during its movement toward the fastening element, a means, which is designed as a second proximity sensor 510, for detecting a second time, at which the driving-in element passes a second position during its movement toward the fastening element, and a means, which is designed as a calculation program 520, for detecting a time difference between the first time and the second time. The setting device further comprises an operator control element 530, which can be adjusted by a user, and a means for detecting a characteristic variable of a fastening element which is to be driven in, which means is designed as a barcode reader 540.

The control variables, as a function of which the control unit 450 controls the amount of energy of the current flowing through the excitation coil 410 during rapid discharge of the capacitor 430, comprise the temperature which is detected by the temperature sensor 460 and/or the capacitance of the capacitor which is calculated by the calculation program 470 and/or the load variables of the setting device which are detected by the acceleration sensor 480 and/or the driving-in depth of the fastening element which is detected by the proximity sensor 490 and/or the speed of the driving-in element which is calculated by the calculation program 520 and/or the adjustment of the operator control element 530 which is adjusted by the user and/or the characteristic variables of the fastening element which are detected by the barcode reader 540.

The setting device further comprises a sensor device, which is designed as an acceleration sensor 550, for detecting an actual acceleration of the driving-in element during a driving-in process and for transmitting a signal, which is dependent on the detected actual acceleration, to the control unit 450. The control unit 450 comprises a memory 560 in which a target acceleration of the driving-in element during a successful driving-in process is stored. As soon as the control unit 450 establishes a difference between the target acceleration and the actual acceleration, for example when the driving-in element is braked more strongly than would be expected in the event of a problem-free driving-in process, the control unit 450 ends the transmission of driving-in energy to the fastening element. This is implemented by way of a portion of the driving-in energy which is provided for the driving-in process being redirected by way of the discharge switch 423 being opened. The discharge current is used, for example, for charging the capacitor 430 or the battery 440. In exemplary embodiments which are not shown, the acceleration sensor detects an acceleration which acts on the fastening element during the driving-in process transversely in relation to the driving-in direction.

FIG. 3 schematically illustrates a manually controlled setting device 600 for driving fastening elements into a substrate, not shown. The setting device 600 is designed as a nail gun and has a housing 605 and a holder 610 which is designed as a nail guide and in which a fastening element, not shown, is held in order to be driven into the substrate along a setting axis B (on the left-hand side in FIG. 3). For the purpose of supplying fastening elements to the holder, the setting device 600 comprises a magazine 620 in which a plurality of fastening elements are held and are transported to the holder 610 one by one. The setting device 600 has a driving-in element 630 which is designed as a piston and comprises a piston plate 631 and a piston rod 632. The driving-in element 630 is provided for conveying the fastening element out of the holder 610, along the setting axis B, into the substrate. In the process, the driving-in element 630 is guided, by way of its piston plate 631, in a guide cylinder 640 along the setting axis B which has a plurality of blow-off openings 645.

The driving-in element 630 is, for its part, driven by a drive 700 which has a positive-pressure chamber 650 which is designed as a combustion chamber for a combustion gas. The drive 700 is provided for generating a positive pressure in the positive-pressure chamber 650 by way of a fuel, which is designed as a fluid gas, being conducted from a fuel tank 670, through an injection line 680, into the positive-pressure chamber 650 by means of an injection valve 660 and being ignited there. In addition or as an alternative, a positive pressure is generated in the positive-pressure chamber 650 by way of a compressor 710 which is supplied with electrical energy by an electrical battery 690 conducting compressed air into the positive-pressure chamber 650 by means of a compressed-air line 720. As soon as the positive pressure acts on the piston plate 631 and therefore on the driving-in element 630, the driving-in element 630 transmits the driving-in energy to the fastening element by means of the piston rod 632. This driving-in process is triggered by operation of a tripping device 730, which is designed as a trigger, by a user of the setting device 600.

The setting device 600 further comprises a control unit 740, a sensor device 750, which is arranged in the region of the driving-element 630 and/or of the holder 610, for detecting an actual acceleration of the driving-in element 630 during a driving-in process and also a first signal line 760 for transmitting a signal, which is dependent on the detected actual acceleration, from the sensor device 750 to the control unit 740. The setting device 600 further comprises a below-off valve 770, which is arranged on the positive-pressure chamber, for blowing off positive pressure in the positive-pressure chamber 750 and also a first control line 780 for transmitting a control signal from the control unit 742 the blow-off valve 770.

As soon as the control unit 740 establishes unusual acceleration or deceleration of the driving-in element 630 by means of a signal which is transmitted from the sensor device 750 via the signal line 760, the control unit 740 reduces the transmission of driving-in energy to the driving-element 630 and therefore to the fastening element. This is implemented by way of the control unit 740 transmitting a control signal to the blow-off valve 770 by means of the control line 780 in order to open the blow-off valve 770. As a result, a positive pressure which may still be present in the positive-pressure chamber 650 is partially or entirely blown off, so that the driving-in element is accelerated to a lesser extent or is no longer accelerated. The risk of damage to the substrate on account of excess driving-in energy is reduced in this way. Finally, the setting device comprises an operator control element 790, for example a reset button, by means of which a user can reset the control unit 740.

The invention has been described using a series of exemplary embodiments which are illustrated in the drawings or are not illustrated. The individual features of the various exemplary embodiments can be used individually or in any desired combination with one another, provided that they are not contradictory. It should be noted that the setting device according to the invention can also be used for other applications.

1. A nail gun for driving fastening elements into a substrate in a driving-in direction, comprising a drive piston driveable in a setting direction to push a fastening element into the substrate; a control unit for controlling a driving-in process of the nail gun; a sensor device for detecting a parameter during the driving-in process and for transmitting a signal, which is dependent on the detected parameter, to the control unit, wherein the control unit controls driving-in energy, which is still to be transmitted to the fastening element as part of the driving-in process, depending on the detected parameter.

2. The nail gun as claimed in claim 1, wherein the control unit reduces the driving-in energy which is still to be transmitted to the fastening element as part of the driving-in process.

3. The nail gun as claimed in claim 2, wherein the control unit ends transmission of driving-in energy to the fastening element.

4. The nail gun as claimed in claim 1, wherein the control unit redirects a portion of driving-in energy which is provided for the driving-in process.

5. The nail gun as claimed in claim 1, wherein the detected parameter comprises a force and/or acceleration which acts on the fastening element during the driving-in process.

6. The nail gun as claimed in claim 5, wherein the detected parameter comprises a force and/or acceleration which acts on the fastening element during the driving-in process transversely in relation to the driving-in direction.

7. The nail gun as claimed claim 1, further comprising a drive which transmits driving-in energy to the drive piston as the drive piston drives the fastening element into the substrate.

8. The nail gun as claimed in claim 7, wherein the drive comprises a positive-pressure chamber for generating a positive pressure in the positive-pressure chamber and allowing the positive pressure to act on the drive piston to transmit driving-in energy to the drive piston, wherein the positive-pressure chamber has a blow-off valve which can be controlled by the control unit, and wherein the control unit controls the driving-in energy, which is still to be transmitted to the fastening element as part of the driving-in process, by opening the blow-off valve during the driving-in process.

9. The nail gun as claimed in claim 8, wherein the positive-pressure chamber comprises a combustion chamber for a solid, liquid or gaseous fuel.

10. The nail gun as claimed in claim 7, wherein the drive comprises an electrical energy store and a coil and is provided for electrically charging the electrical energy store, promptly discharging said electrical energy store, conducting a discharge current, which is produced in the process, through the coil and allowing electromagnetic energy which is released in the driving-in process to act on the drive piston in order to transmit driving-in energy to the drive piston, wherein the drive comprises a switch with which a current flowing through the coil can be controlled, and wherein the control unit controls the driving-in energy, which is still to be transmitted to the fastening element as part of the driving-in process, by operating the switch during the driving-in process.

11. A method for operating a nail gun for driving fastening elements into a substrate in a driving-in direction, comprising a drive piston which can be driven in a setting direction in order to push a fastening element into the substrate, comprising
detecting a parameter during a driving-in process
controlling driving-in energy, which is still to be transmitted to the fastening element as part of the driving-in the process, depending on the detected parameter.

12. The method as claimed in claim 11, further comprising
ending the transmission of driving-in energy to the fastening element.

13. The method as claimed in claim 11, further comprising
redirecting a portion of driving-in energy which is provided for the driving-in process.

14. The method as claimed in claim 11, wherein the detected parameter comprises a force and/or acceleration which acts on the fastening element during the driving-in process in relation to the driving-in direction.

15. The method of claim 11, wherein controlling driving-in energy comprises reducing the driving-in energy.

16. The method of claim 14, wherein the detected parameter comprises a force and/or acceleration which acts on the fastening element during the driving-in process transversely in relation to the driving-in direction.

17. The nail gun as claimed in claim 2, wherein the control unit redirects a portion of driving-in energy which is provided for the driving-in process.

18. The nail gun as claimed in claim 2, wherein the detected parameter comprises a force and/or acceleration which acts on the fastening element during the driving-in process.

19. The nail gun as claimed in claim 3, wherein the detected parameter comprises a force and/or acceleration which acts on the fastening element during the driving-in process.

20. The nail gun as claimed in claim 4, wherein the detected parameter comprises a force and/or acceleration which acts on the fastening element during the driving-in process.
